(19) United States
(12) Patent Application Publication
(10) Pub. No.: US 2002/0156699 A1
(43) Pub. Date: Oct. 24, 2002

(54) System of upselling in a computer network environment

(76) Inventors: Joseph Gray, Temecula, CA (US); Brent Peterson, Nuevo, CA (US)

Correspondence Address: CISLO & THOMAS, LLP, 233 WILSHIRE BLVD, SUITE 900, SANTA MONICA, CA, 90401-1211, US

(21) Appl. No.: 10/125,877

(22) Filed: Apr. 19, 2002

Related U.S. Application Data
(60) Provisional application No. 60/285,536, filed on Apr. 20, 2001.

(51) Int. Cl. G06F 17/60

(52) U.S. Cl. 705/26

(57) ABSTRACT

A method of transacting sales through a global computer network, and more particularly, to a method of transacting multi-faceted sales online the practice of which has been at odds with the standard e-commerce shopping cart approach. Multi-faceted sales are transacted using a multi-step process which supports the sale of “base” products and related “upsell” products while resolving consumer price resistance and order abandonment issues that plague other e-commerce shopping cart approaches. Upon visiting a website and purchasing the advertised or other base products, the system completes the base sale transaction by collecting the necessary customer information. The sale in completed and the customer is notified of the completion of the sale. Thereafter, the website offers for sale to the customer one or more related upsell items as a separate and distinct transaction from the base sale transaction. The sale of any upsells is presented as distinct from the already consummated base product transaction, and the sale is ultimately consolidated with the base product sale for notification and shipment purposes. By creating a way to support multi-faceted sales online, Internet sales become equally attractive to Direct Response Advertisers as conventional 800 telephone number operator models, allowing such advertisers to encourage customers interested in purchasing a product advertised on television, in print, or over the Internet to purchase the product through the advertiser's website, and thereafter offer the customer one or more upsell products, all without risking losing the customer's interest in and purchase of the advertised base product.

### CROSS-REFERENCES TO RELATED APPLICATIONS

This patent application is related to U.S. Provisional Patent Application Serial No. 60/285,536 filed Apr. 20, 2001 for METHOD OF UPSELLING AND REVENUE SHARING, which application is incorporated herein by this reference thereto.

### BACKGROUND OF THE INVENTION

This invention relates generally to a method of transacting sales through a global computer network, and more particularly, to a method of transacting multi-faceted sales online the practice of which has been at odds with the standard e-commerce shopping cart approach. Multi-faceted sales are transacted using a multi-step process which supports the sale of “base” products and related “upsell” products while resolving consumer price resistance and order abandonment issues that plague other e-commerce shopping cart approaches.

The present invention was initially developed to support the multi-faceted sales approach commonly used by Direct Response Television Advertisers. The conventional method by which Television Advertisers sell products via an 800-number live operator call processing environment is well known in the art. Basically, a product is advertised over the television and customers are encouraged to call the number shown in the advertisement. A customer calls the number, is thereby patched through to a call center, where their name, address, and credit card information is captured over the phone to consummate the sale of the advertised product, known as the “base” product. In some cases there are more than one base product that a consumer can choose from as in the case of a music offer that is available in either a Compact Disc format or on Audio Tape. In yet other cases, one or more pre-sell options may be offered. For example, in the case of advertising a base product for five payments of $19.95, a pre-sell option may be used to provide an incentive to consumers who are willing to make one easy payment of $99.75 instead of five payments of $19.95. After the caller's information is captured, including credit card information, and the correct base product is chosen and/or pre-sell is made, if applicable, the operator then offers additional items that can be added to the base purchase. These additional items are commonly known as “upsell” products.

These upsell products typically relate to the advertised product, such as additional units at a discount, a related product, a warranty, etc., and they usually have a proven track record of being of interest to customers of the base product. The telephone operator transacts the multi-faceted sale by telling the customer about each upsell product, including the benefits of the product, the price, and the savings available with an immediate purchase. As the operator offers each upsell, the customer chooses whether or not to accept the offer. After the operator has presented all available upsells the call is then typically concluded without the operator providing a sales total. The customer is simply provided with shipping information such as, “Your order will arrive in 2-3 weeks” and thanked for their order.

Direct Response Advertisers (“DRAs”) are by nature forced to use a multi-faceted sales approach in order to increase revenues to a level where they can profit due to the high costs of direct advertising. For example, when advertising a product for a low price, such as for instance $19.95, it is imperative that upsell products are offered and converted at the point of purchase otherwise the advertiser would likely not generate enough income to pay for the costs of the advertising time. Because of this economic reality, DRAs usually offer upsells as part of their multi-faceted sales approach. In order to keep upsell percentages as high as possible, and to avoid order abandonment, DRAs generally do not provide sub-totals during the telephone sales process nor a grand total at the end of the sale for fear that the aggregate amount might trigger an adverse reaction.

One of the greatest areas for growth for DRAs is the Internet. DRAs, however, have been reluctant to enter into the Internet arena due to the several ways in which currently available E-Commerce Shopping Cart Technology is inherently incompatible with the multifaceted sales approach DRAs use.

The most widely used method of making Internet transactions today is the online shopping cart method. Using the online shopping cart method, a customer may select a product or service that he or she desires by pointing at the item on a computer screen and clicking a computer mouse button. This causes the item to be placed on a list or “in a shopping cart” that keeps a tally of all currently selected items for view by the customer. Additional individual items can be selected and added to this shopping cart at anytime, and selected items can also be easily removed from the shopping cart.

As the customer adds items to the shopping cart, the total price of the accumulated sale grows. One result of using this common shopping cart approach is that, as a customer accumulates different items in his or her shopping cart, the shear cost of the accumulating bill may encourage the customer to abandon the entire shopping cart altogether, commonly referred to as “shopping cart abandonment.”

As discussed above, DRAs have developed valuable and proven methods to generate sales using a multi-faceted sales approach which generally does not include providing consumers with sub-totals during the purchase or a grand-total at the end of the purchase. Moreover, DRAs have developed proven methods of offering and selling upsell products to consumers at the time of purchase. Under a typical shopping cart method, DRAs are not able to offer upsell products separate from the base products since all products placed into the shopping cart basket are treated as a single larger sale causing unacceptable order abandonment. Further, since DRAs use multiple upsells for every base product it becomes very difficult to present all relevant upsells to consumers as they place multiple base products in their shopping cart. For example, a consumer may place four base products into their shopping cart each of which may have four upsells. This would require the consumer to be presented with a total of 16 upsells at checkout, which shopping carts were not designed to support. Even if such upsells could be supported, the resulting grand-total upon checkout would lead to the undesirable result of the customer ultimately developing “sticker shock” and abandoning the shopping cart entirely.

In the absence of an alternative to the online shopping cart model to support multifaceted sales over the Internet, DRAs that rely upon upsells as part of their business model have typically chosen either to forego this potential upsell revenue over the Internet or to forego Internet transactions entirely. That is, once a DRA has expended substantial sums attracting a customer to purchase the base product, the DRA is unwilling to send the consumer to a website where they are unable to offer their upsell products and/or risk order abandonment by doing so. Thus, for any such sale transacted over the Internet, the DRA would be forced to forego these upsells, given the limitations of online shopping-cart technology, and as a result may enjoy substantially less revenue per customer over the Internet than through the conventional call center method.

Thus, DRAs have not been able to take full advantage of their multi-faceted sales approach through the Internet without concomitantly risking losing the very customer transaction that they have spent so much effort to attract. Therefore, what is needed in the art is a method for use over the world wide web of generating upsells while nevertheless eliminating online shopping cart abandonment so that DRAs can enjoy the increased revenue that results from upsells when selling over the Internet, just as they do through the telephone call center model.

### SUMMARY OF THE INVENTION

The present invention involves a multi-step method of selling products over a global computer network such as the Internet. The method involves a first transaction, the sale of target or base products, and thereafter a second transaction, the sale of one or more upsell products.

An interested customer first visits a website. At the website, the customer easily finds a particular company's base products “as seen on TV” or other advertisements. The customer decides to purchase the advertised or other base products, and completes the purchase by clicking a button evidencing an acceptance of the offer for sale of the product displayed on the website. some pre-sell information, billing information, and shipping information may be required, after which the sale is completed and the customer is notified of the completion of the sale. Thereafter, the website offers for sale to the customer one screen at a time each of the upsell items as a separate and distinct transaction from the base sale transaction.

The customer is free to purchase any one or more, or none, of these upsell products. If the customer elects not to buy any upsell products, or if the customer otherwise abandons the offer of upsell products, the upsell transaction is deemed to be not accepted, but the already consummated sale of the base products is not compromised and will still be shipped to the customer. In the case of a base sale only, a email receipt may be sent to the customer informing the customer about only the consummated sale of the base products. However, if any upsells were purchased after the base sale transaction, they will also be itemized in the email receipt along with the grand total of the now consolidated sale.

The multi-step sales process of the invention allows DRAs to keep the sale of the base products separate from the upsell products during the online transaction. By doing so, the base product sale is never compromised which is another significant improvement over conventional telephone ordering methods. With telephone ordering methods, if a customer hangs up the telephone at anytime during the upsell transaction, the base sale transaction is usually considered abandoned and rescinded. Additionally, by treating the upsells as a separate sale online, DRAs are able to convert a large and more difficult sale into two smaller sales making the sales process much easier to convert.

In an alternative embodiment of the present invention, each upsell product or service constitutes a separate and distinct transaction that is fully consummated before the customer is offered another upsell product or service. However, in order for the DRAs to process the web orders in the same manner as the telephone orders, the ultimate sale must be consolidated so that the DRAs can bill and ship both the base products and the upsells together as a single purchase which is consistent with their normal business practices. This is an important distinction because otherwise DRAs would have to change their billing and fulfillment practices which would be very expensive and time consuming.

Therefore, it is an object of the present invention to provide a method that would open up Internet sales to DRAs and to provide a method which is compatible with the normal business practices of DRAs. That is, it is an object of the present invention that, by making Internet sales a multi-step process, and by separating the base sales from the upsell sales online, and ultimately consolidating the two separate sales, will encourage DRAs to advertise website addresses in their advertising, and thus allow for Internet transactions in their overall marketing efforts. Still another object of the present invention is to open up the DRAs to more novel e-commerce models, including collaboration by companies having complimentary inventories, even if directly competing in certain instances, through a network of websites managed by a neutral host site.

A still further object of the present invention is to provide a method for promoting product-specific upsells while protecting against abandonment of the base product sales. These and other objects and advantages of the present invention will be apparent from a review of the following specification and accompanying drawings.

### BRIEF DESCRIPTION OF THE DRAWINGS

FIG. 1 is a flowchart illustrating one embodiment of the present invention showing a method of upselling.

FIG. 2 is a printout of a page of a website showing one embodiment of the present invention showing a number of base products.

FIG. 3 is a printout of a web page showing a response from the website to a customer order as in one embodiment of the present invention.

FIG. 4 is a printout of a web page showing customer billing information as in one embodiment of the present invention.

FIG. 5 is a printout of a web page showing a credit card payment screen as in one embodiment of the present invention.

FIG. 6 is a printout of a web page of one embodiment of the present invention showing a successful purchase of a base product and an offer for an upsell product.

FIG. 7 is a printout of a web page as in one embodiment of the present invention showing another sample upsell product.

FIG. 8 is a printout of a web page as in one embodiment of the present invention showing yet another sample upsell product.

FIG. 9 is a printout of a web page showing a special offer verification screen as in one embodiment of the present invention.

FIG. 10 is a printout of a web page showing a sample thank you notice as in one embodiment of the present invention.

FIG. 11 is a printout of a web page showing a sample email confirmation as in one embodiment of the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

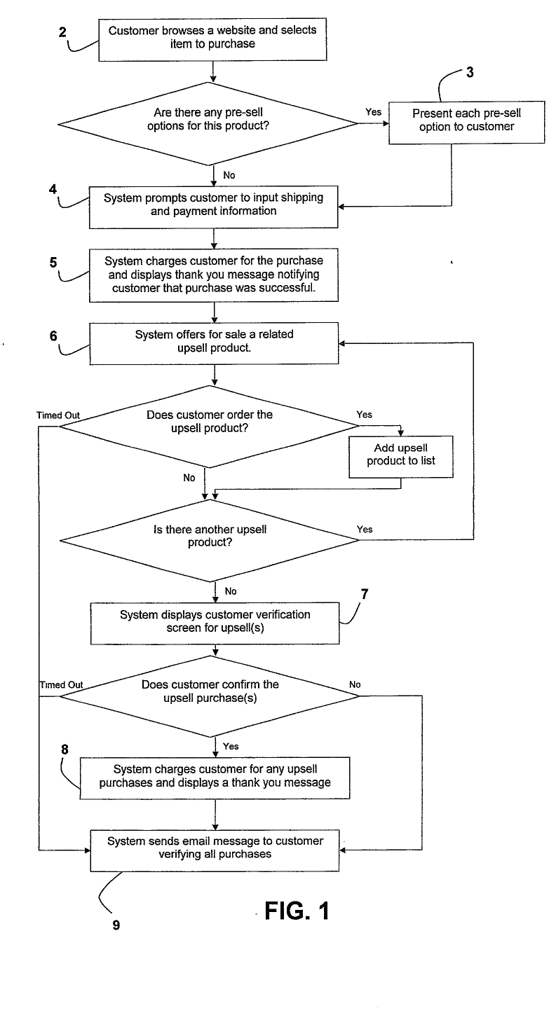

FIG. 1 shows a flow chart of the basic steps involved in one embodiment of the present invention, and is discussed in detail below. Such an embodiment of the present invention involves the display of a product in an advertisement whether in printed materials or broadcast over the television, radio, Internet, or other media. The advertisement offers one or more ways for interested customers to purchase the advertised or base product, one of which is through a website. While the present application uses the term “product” to refer to various commercially available items for sale, the term as used herein is intended to be construed broadly, additionally including, for example, the ordinary and customary meaning of the term “services” for the purposes of the present invention.

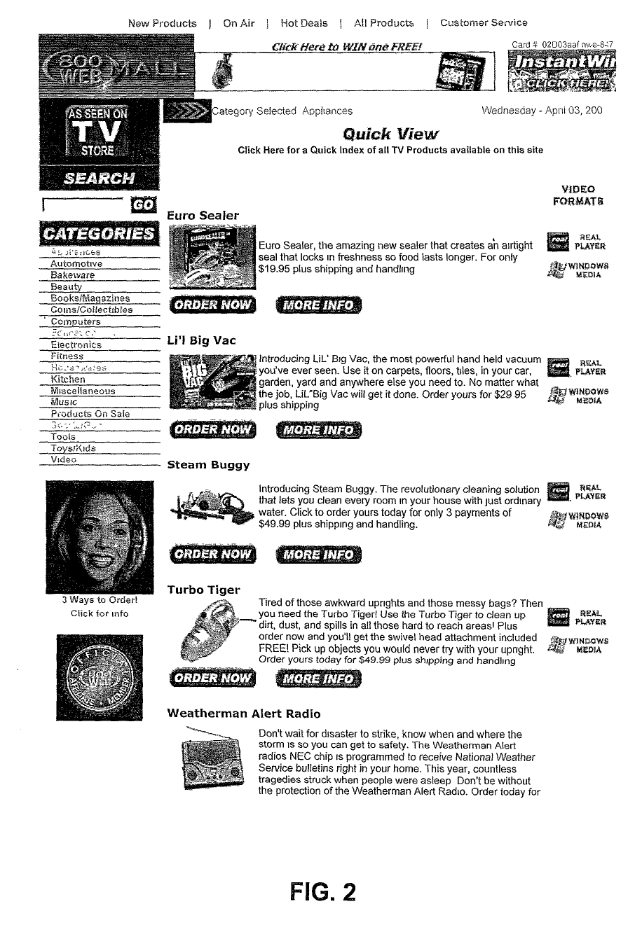

In this embodiment, if an interested customer then visits the website, he or she will encounter a screen similar to the screen shown in FIG. 2. The advertised product is prominently displayed on the first web page of the website, as well as an “Order Now” button and a “More Info” button. The product is displayed along with a brief description of the product and the price. The Internet website may also support graphic and animated depictions of the product or streaming video and audio from the advertisement or promotion. Thus, there are also links to download free software to facilitate the graphics or animation, if needed.

In the embodiment illustrated in FIG. 2, there are five different base products on display, which may correspond to five different advertisements currently running on television, radio, or the like. The customer easily finds the base products “as seen on TV” or other advertisements. Instead of adding the items to a shopping cart, the consumer instead clicks on the “Order Now” button located next to the desired base product. The website receives this response as an acceptance of the offer for sale which in turn triggers a multi-faceted in sales script.

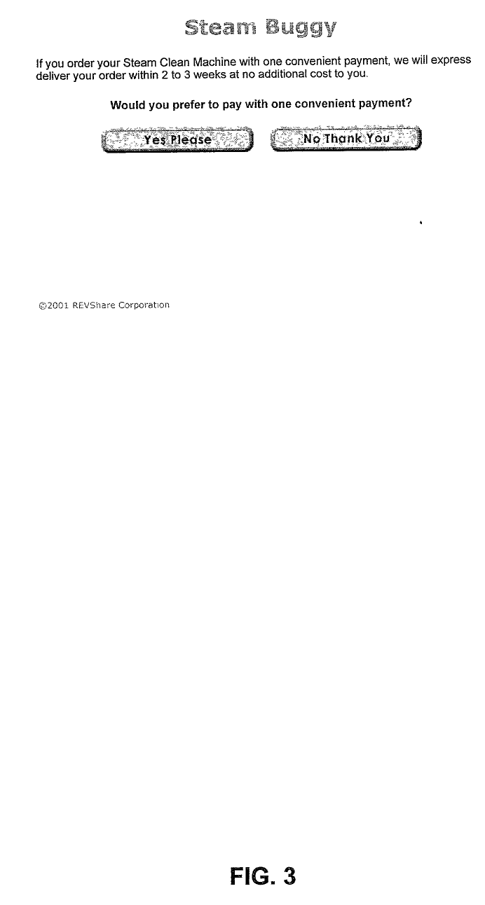

Upon receiving this instruction, the website immediately displays a short series of convenient information and confirmation screens as shown in FIGS. 3 through 5. The script initially guides the customer through the simple steps necessary to purchase the base products, which may include base product selection, if applicable (as in the case of a music offer available on compact disc or cassette tape), any applicable pre-sell options, along with entering information such as a billing address, shipping address, credit card, etc.

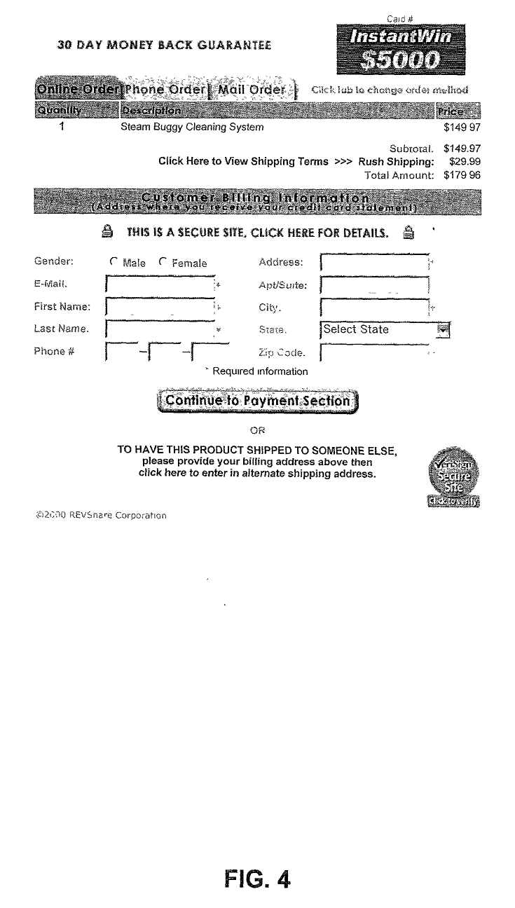

Thus, the customer is guided through the steps necessary for proper purchasing, processing, and shipping of the product to the customer. For example, in FIG. 3, the customer may select among alternative payment plans. Then, the website displays a screen, such as FIG. 4, showing the payment(s) under the selected plan, including any shipping or rush shipping charges, and asks the customer to enter his or her billing and shipping information.

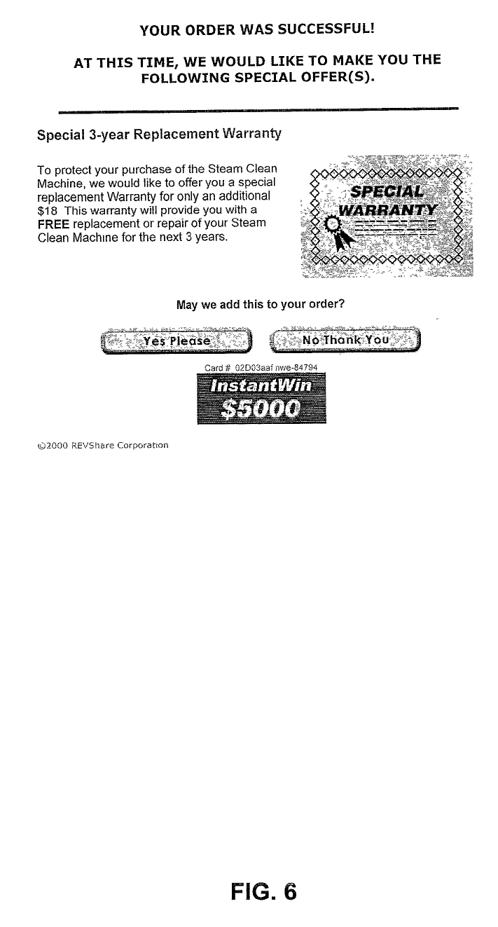

Once the billing and shipping information has been entered or acknowledged, the website displays a “Pay by Credit Card” web page, again summarizing the selected base product and pricing plan, including any shipping charge and sales tax, as well as the billing information just entered. The web page then asks for the customer's credit card number and expiration date, and offers to enter the customer in a monthly drawing for free prizes. After the customer enters his or her credit card information, the information is verified and matched with the billing information. If all of this information is approved, the sale is completed or consummated, and then the website displays a web page notifying the customer that “Your Order Was Successful,” as shown in FIG. 6, or other similar notification that the sale has been completed.

Alternatively, if the system recognizes the customer from previous transactions, the system uses any stored information to facilitate or bypass the entry of this information, further streamlining the transaction, provided the customer elects this option. The customer decides to purchase the advertised or other base products, and completes the purchase. Thus, the transaction may be completed with a minimum amount of effort by the customer, and he or she is presented with an order completion screen notifying the customer that the order was successful. Thereafter, the website offers for sale to the customer one screen at a time each of the upsell items.

After the sale of base product has been successfully completed, the website will offer to the customer one or more additional and related products or services as a separate and distinct transaction from the foregoing base product transaction. Often, the DRA has developed through the experience of previous sales of the base product, or simple due to the nature of the base product, that a customer of the base product is likely to be also interested in one or more these related products or services. These related products and services are referred to herein as “upsell products.” In FIG. 6, for example, the service of a special warranty is offered for a reasonable additional charge. If the customer wishes to purchase the special warranty, he or she selects the “Yes Please” button. If not, he or she can select “No Thank You” or simply not respond at all.

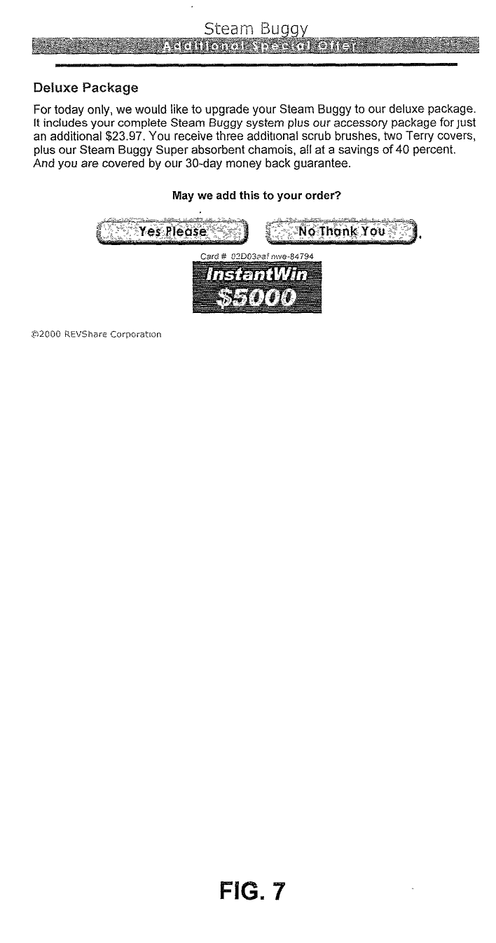

If the customer selects either “Yes Please” or “No Thank You,” the website may then display another web page offering another upsell product. In FIG. 7, for example, a deluxe package is offered to the customer, including various accessories commonly used with the fit Steam Buggy product. The additional price of this upsell product is displayed along with a description of the accessories included in the deluxe package. Again the customer could select “Yes Please,” “No Thank You,” or simply provide no further responses, including leaving the website or turning off the computer, for example.

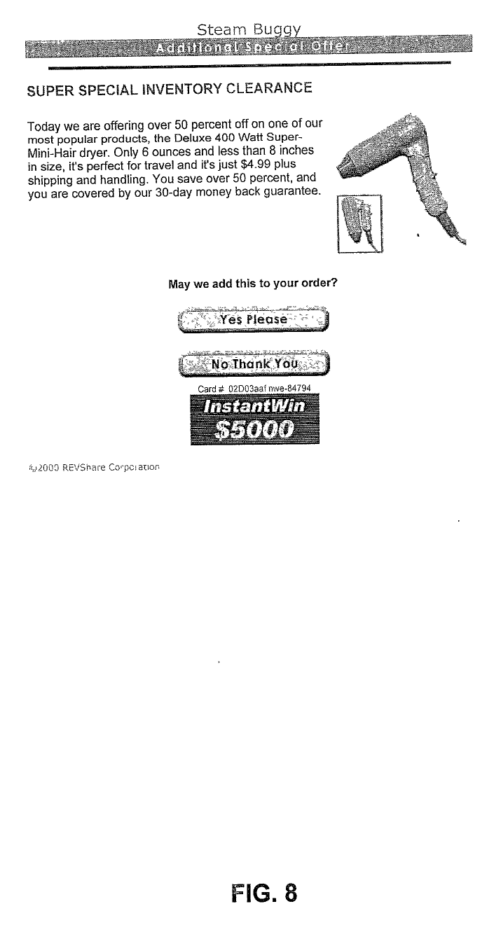

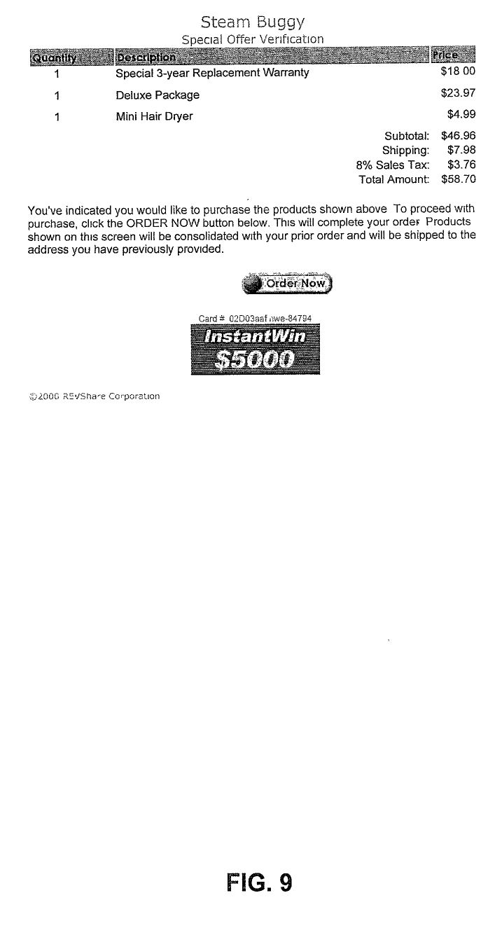

If one of the buttons is selected, then yet another upsell product is offered to the client, such as the clearance item shown in FIG. 8, and the options discussed above are repeated. The customer is free to purchase any one or more, or none, of these upsell products. In one embodiment, if the customer accepts one or more upsell products, the customer is presented with a “Special Offer Verification Screen,” such as the one in FIG. 9, showing an itemized breakdown of only the upsell products or services that the customer has selected, not including the amount of the already-purchased base product, and a message, such as,

You've indicated you wish to purchase the products shown above. To proceed with purchase, click the ORDER BUTTON below. This will complete your order. Products shown on this screen will be consolidated with your prior order and shipped to the address you have previously provided.

It is important to note that by treating the upsells as a second sale, the upsell purchase price displayed is much less than if one displayed the sum of both the upsells and the base sale. The lower price displayed helps to reduce consumer “sticker shock” and order abandonment.

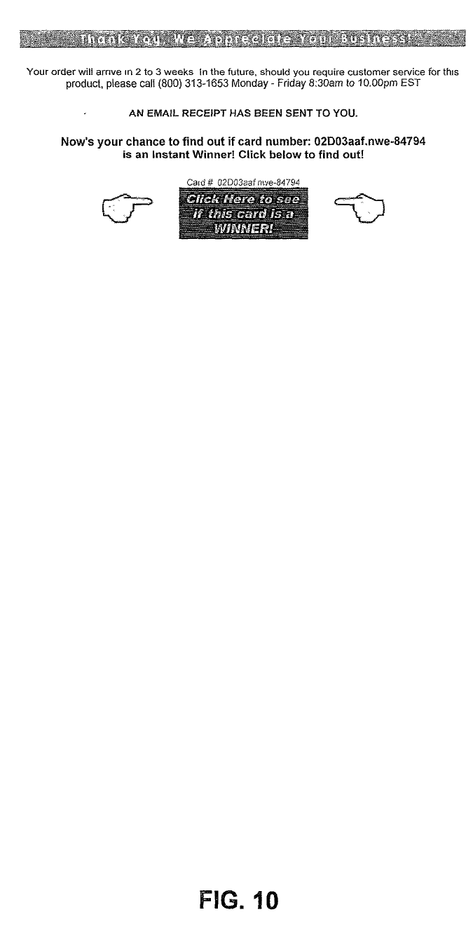

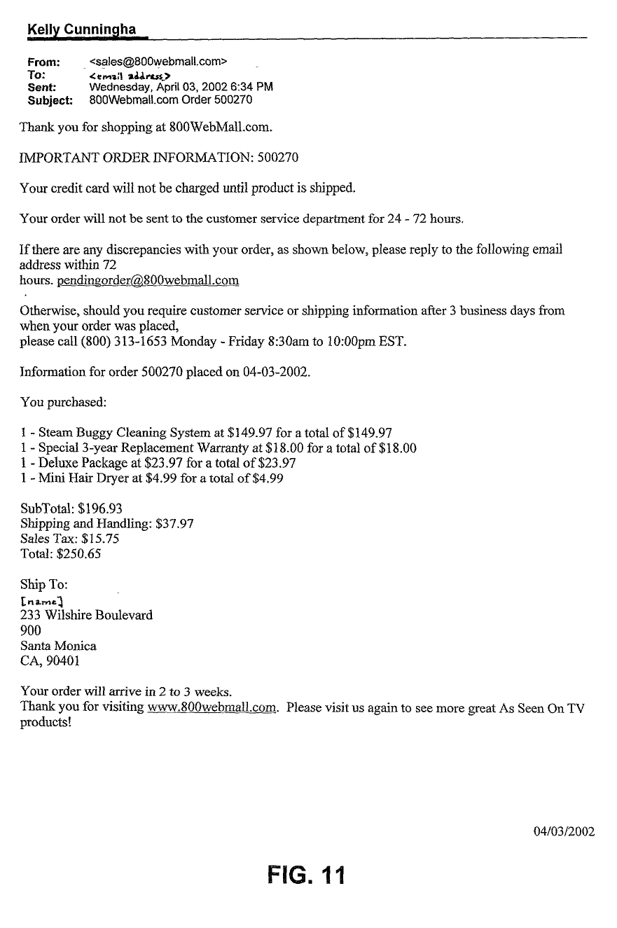

This methodology also allows for a “one-click” consolidation of the upsell sale with the prior base sale without the consumer having to provide their address or credit card information again which helps to further increase upsell conversion. If the customer selects “Order Now,” the customer is charged for the selected upsell products, and the website then displays a “Thank You” page, such as the one shown in FIG. 10, giving an estimated delivery time, and other similar information, and an email message is sent to the customer's email address, as shown in FIG. 11. The sale of the base product is consolidated with the sale of any purchased upsell products for the purpose of confirming and informing the customer of the consolidated transaction and total sales price, such as in a subsequent confirmation email message. The purchased base product is itself combined with the purchased upsell products, if any, and together they are shipped to the customer. Where a service is purchased, ordinarily a writing of some nature sufficient to identify and memorialize the purchase of the service can be delivered to the customer.

If, on the other hand, the customer fails to respond to this or any previous web page, the website provides the customer a predetermined length of time to respond and monitors the customer's responses after each upsell offer. Presently, the best mode with respect to this amount of time delay appears to be on the order of fifteen or thirty minutes. However, other amounts of time may also be used within the purposes of the present invention, such as ten minutes, an hour, or even until a predetermined time of the day or night, for example. At any point during this upsell phase of the transactions, if the customer does not respond to a web page request within this predetermined amount of time, the transaction is treated as if the customer declined the offers for any of the upsell products. Then, the customer is automatically logged out of the system which is beneficial to the customer for security purposes. When the system automatically logs the customer out and treats the inaction as if the customer affirmatively declined the upsell offers, no subsequent entry by the customer or by some third party can be mistaken for an acceptance of the selected upsell products. If any such timeout occurs, an email message is sent to the customer verifying the purchase of the base product, and the base product alone is shipped to the customer's shipping address.

The present invention further contemplates that this process of offering upsell products may itself be further broken up into two or more phases based on statistical or other means by which the DRA has determined that there may be a degree of diminishing returns with respect to certain more peripheral upsell items. If this is the case, the DRA may not want to jeopardize certain other more critical upsell items, such as ones that have a more proven value to the customers of the base product. Accordingly, just as the two-phase Internet transaction method described above protects the sale of the base products against the possibility of abandonment during the later upsell offer phase, the multi-phase approach during the upsell phase could protect the sale of more critical upsell products or services from abandonment during the offers of more tangential or experimental upsell products and services.

This multi-step approach of separating the sale of the base products from the sale of the upsell product(s) assures that the sale of the base products is never compromised since, unlike a shopping cart, no other products and/or upsells are ever offered at the time the consumer orders and confirms the base products. Only after the base product sale is transacted and ended are upsells then presented to the consumer which consists generally of one or a plurality of unique upsells specific to the base product.

Instead of treating the upsells as part of the original sale, they are purposely treated as a new and separate sale to break what would otherwise be a larger monetary sale into two smaller sales, thus reducing the risk of order abandonment for either sale, but especially for the sale of the base product. However, in order to be compatible with the business model of the Direct Response Industry, product-specific upsells are consolidated with the base product and shipped to the consumer as a single shipment by the DRA. Thus, this allows for compatibility of the Internet base and upsell transactions with the conventional Direct Response backend business model. Since the economic advantage of being able to support upsells on the Internet in an environment that is compatible with the typical offline business model, the present invention allows DRAs to increase their own profitability by including a web address in television spots and transacting such sales over the Internet.

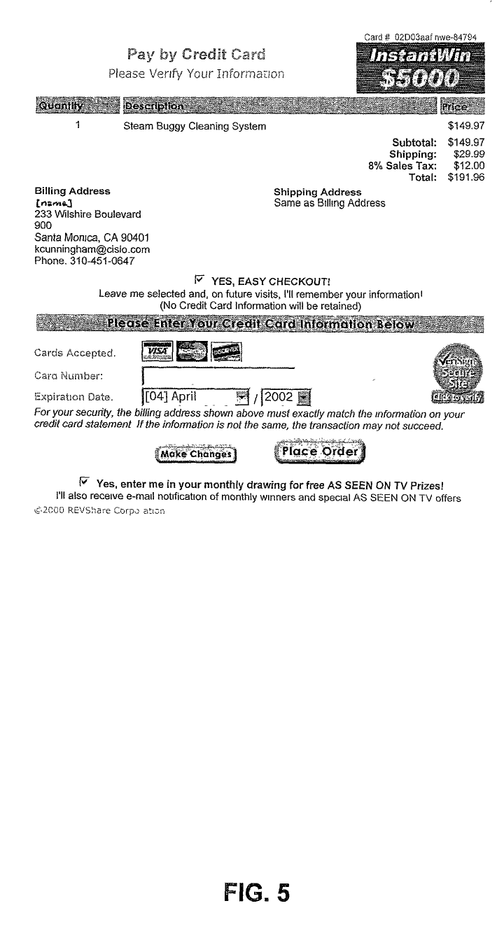

Returning to FIG. 1, this flow chart then represents one embodiment of the present invention illustrating such a method of upselling over the Internet. First, a customer browses a website and selects a single base product for purchase 2, such as the Steam Buggy shown in FIG. 2. At this point, the system forwards the customer directly to a transaction script, such as in FIGS. 3 through 6. For some base products, the script may contain one or more pre-sell options 3, such as an alternative payment plan as shown in FIG. 3. As discussed above, other pre-sell options may exist, such as, in the case of a purchase of software, which computer operating system the customer uses and whether the customer would like the software on disk or CD-ROM. After the pre-sell questions have answered, the customer is shown a breakdown of his or her base sale transaction, and verifies the order by inputing his or her contact information 4, as in FIG. 4, which can be stored for later usage, such as in the form of a cookie on the customer's computer. As shown in FIG. 5, the customer is next prompted for payment information and is shown the specific charges that he or she will incur. The customer may then be offered an option of rush shipping, if available, which would be an additional charge. The customer can either accept or decline the offer of rush shipping. A rush shipping option is not required and in some instances not available and, therefore, would not be offered under those circumstances.

Once the customer enters his or her payment information 4 and clicks on the button to place the order, the transaction script completes the transaction and charges 5 the customer the price of the base product, plus tax and shipping costs. If the transaction was successful, the system informs the customer that the transaction was successfully completed and then proposes an upsell product 6, the sale of a similar or related item or items. FIG. 6 shows an example of how a successful order and subsequent offer of an upsell product 6 may be depicted to the customer, and FIGS. 7 and 8 illustrate examples of further offers of upsell products 6.

Thus, while there may be some pre-sell options 3 presented prior to the completion of the base transaction, such as alternative payment options for example, the upsell offers are presented to the customer only after the completion of the base sale transaction. In this way, the present invention separates the method into two distinct phases, first, the sale of the base product and, second, the sale of one or more upsell products or services. As a result, the primary sale, namely the sale of the base product, is already completed before additional sales are offered or made.

The customer can either accept or deny one or more of the individual upsell products 6. If the customer wants to accept the purchase of one or more of the upsell items 6, the customer is either sent to a special offer verification and confirmation screen 7 or offered another upsell product 6. A plurality of upsell products 6 may be offered to the customer before the customer proceeds to the special offer verification screen 7, or alternatively, the customer may be sent to a special offer verification screen 7 after each time the customer accepts any single upsell item 6. Still another embodiment of the present invention displays no separate special offer verification screen, but rather takes the customer's response to each upsell offer as either final acceptance or final rejection of the offer.

Where a special offer verification screen 7 is presented to the customer after all of the upsells 6 relating to the specific base product are presented, the special offer verification screen 7 consolidates all upsell products 6 showing a total price for the agreed upon upsell products, as shown in FIG. 9. The customer may accept or decline the purchase of these upsell products 6 by confirming on this special offer verification screen 7 or simply exiting the screen without confirming, respectively.

Once a confirmation is made, the customer will be charged 8 using the same payment information 5 that the customer has previously entered. The purchased upsell products themselves are combined with the purchased base product, and all purchased products are then shipped to the consumer as a single shipment. If, on the other hand, the customer does not confirm the upsell purchase or otherwise exits the system at anytime without specifically confirming at the special offer verification screen 7, no additional charge will be incurred to the customer. However, the customer will have still been charged for and will still receive the base product, since the purchase of the base product had already been completed by the customer before being offered any upsell items.

After the billing is completed, a thank you message, similar to that in FIG. 10, will appear on the customer's screen, which may include an estimate of the delivery time and a telephone number for customer service. The customer may also be informed in this screen that an email receipt 9 will be sent to the email address that was specified by the customer during the transaction. The system then sends an email receipt 9, similar to the one in FIG. 11, to the customer's specified email address containing information regarding the entire consolidated A purchase such as items ordered, costs of items including shopping costs and taxes, if applicable, estimated time of delivery, and shipping address. The present invention equally contemplates that other information may also be included with the thank you message and/or email receipt 9, such as information related to the completed transactions, offers for further products and/or upsell products, offers to enter the customer's information into various games or drawings for additional prizes, and the like.

If, on the other hand, the customer does not confirm the order of the upsells or otherwise exits the system at the special offer verification screen 7, the system, after a predetermined period of time of receiving no additional purchase information, will treat the upsell transaction as not confirmed and send the customer an email receipt 9, confirming the purchase of the base product alone.

It is important to note that the consolidation of the base products with the upsells, and resulting grand total, is only detailed in the email receipt and provided to the consumer after the purchase is complete. This is critical in order to reduce online order abandonment. Consumers are allowed to respond after receiving their email receipt should they wish to change and/or cancel their order. In practice, an insignificant percentage of consumers cancel their order upon receipt of the consolidated order email receipt illustrating that consumers do not react negatively to the two-step order consolidation process. In fact, by showing and confirming the total sale of the base products, followed by showing and confirming the total sale of the upsell products, the current invention actually provides a much greater level of price disclosure than normal telephone order processing environments. As a result, the current invention produces much fewer product returns than the conventional telephone ordering process.

This multi-faceted system and method of upselling also makes it possible for DRAs to take greater advantage of new technologies over the Internet, including applying the system to a revenue sharing network of Internet websites managed by a neutral host organization. Through the management of the host, participating DRAs are able to provide their customers their own inventory of products, including upsells, and also any complimentary inventory of other participating DRAs and organizations, along with their upsells. Moreover, participating DRAs may therefore benefit from their own products and services being offered to the customers of the other participating DRAs and organizations. Even competing DRAs can participate since conflict filters can be used so that participating organizations can restrict the products that appear so that other directly competing products do not appear with their own on any particular web page when viewed by their clients.

The present invention thus can be fully integrated with such a revenue sharing system and method, which is described more fully in Applicant's co-pending application filed on Apr. 19, 2002 entitled SYSTEM of REVENUE SHARING IN A COMPUTER NETWORK ENVIRONMENT, serial number not yet assigned. That application, including it description, is incorporated herein by reference.

While the present invention has been described with regards to particular embodiments, it is recognized that additional variations of the present invention may be devised without departing from the inventive concept.

What is claimed is:

1. A method of selling products or services over a global computer network comprising the steps of:
receiving an acceptance of an offer for sale of a base product or service over a website within a global computer network,
completing a sale of said base product or service to a customer,
notifying the customer of the completion of said sale, and
thereafter offering for sale one or more upsell products or services as a separate and distinct transaction from the completed base product transaction.

2. A method as set forth in claim 1, further comprising the steps of:
receiving an acceptance of an offer for sale of at least one upsell product or service; and
completing a sale of said at least one upsell product or service to the customer.

3. A method as set forth in claim 2, further comprising the step of notifying the customer of the completion of said sale of said at least one upsell product or service.

4. A method as set forth in claim 2, further comprising the steps of:
displaying a thank you message after the completion and consolidation of a sale of a base product or service and any upsell product or service; and
sending an email confirmation thereof to the customer.

5. A method as set forth in claim 2, further comprising the step of consolidating the sale of said base product or service and the sale of said at least one upsell product or service.

6. A method as set forth in claim 5, further comprising the step of combining said base product or a certificate identifying said base service with said at least one upsell product or a certificate identifying said at least one upsell service.

7. A method as set forth in claim 6, further comprising the step of shipping said combination of said base product or certificate identifying said base service and said at least one upsell product or certificate identifying said at least one upsell service.

8. A method as set forth in claim 2 wherein said step of offering for sale one or more upsell products or services occurs only after the completion of said sale of said base product or service.

9. A method as set forth in claim 1, further comprising the steps of:
monitoring said customer's responses for a predetermined amount of time;
thereafter treating the absence of any response from the customer during this predetermined amount of time as a failure by the customer to accept said offer for sale of said one or more upsell products or services; and
shipping said base product or a certificate identifying said base service to the customer.

10. A method as set forth in claim 9, further comprising the step of sending an email confirmation of said sale to the customer.

11. A method for offering for sale two or more products or services over a global computer network, comprising the steps:
offering for sale a base product or service over a website within a global computer network;
consummating a sale of said base product or service in a base sale transaction; and
thereafter offering for sale one or more upsell products or services.

12. A method as set forth in claim 11, further comprising the step of consummating a sale of one of said one or more upsell products or services in an upsell transaction being separate and distinct from said base sale transaction.

13. A method as set forth in claim 12, further comprising the step of consolidating the base sale transaction and the upsell transaction after the consummation of both said transactions.

14. A method as set forth in claim 13, wherein the step of consolidating a sale of said base product or service and a sale of said one or more upsell products or services comprises sending notification of the consolidation to the customer.

15. A method as set forth in claim 13, further comprising the step of combining said base product or a certificate identifying said base service with said at least one upsell product or a certificate identifying said at least one upsell service.

16. A method as set forth in claim 13, further comprising the step of shipping said combination of said base product or certificate identifying said base service and said at least one upsell product or certificate identifying said at least one upsell service.

17. A method as set forth in claim 11 wherein said step of offering for sale one or more upsell products or services occurs only after the step of consummating of said base transaction.

18. A method as set forth in claim 11, further comprising the steps of:
monitoring the customer's responses for a predetermined amount of time after each subsequent web page is displayed;
thereafter treating the absence of any response from the customer during said predetermined amount of time as a decision by the customer to decline said offer for sale of said one or more upsell products or services; and
shipping said base product or a certificate identifying said base service.

19. A method as set forth in claim 11, further comprising the step of sending a notification to the customer of a sale of said base product or service.

20. A method of offering and selling base products or services and thereafter effectively offering and selling upsell products or services over a global computer network, said method comprising the steps of:
receiving a request for purchase of a base product or service over a website within a global computer network;
completing a sale of said base product or service to the customer and notifying the customer of the completion of sale of said base product or service;
thereafter offering for sale one or more upsell products or services but only after completion of said sale of said base product or service;
completing a sale of any one or more upsell products or services selected by the customer; and
providing subsequent consolidation of all sales made to said customer.

21. A method as set forth in claim 20, wherein the step of providing subsequent consolidation of sales of the products or services comprises determining and informing the customer of the total price of said consolidated sale of said base product or service and any upsell products or services.

22. A method as set forth in claim 21, wherein the step of informing the customer of the total price occurs after said step of completing said sale of any one or more upsell products or services.

23. A method as set forth in claim 21, wherein the step of informing the customer comprises sending an email to the customer.

24. A method as set forth in claim 20, further comprising the steps of:
displaying a thank you message after the completion of said sale; and
sending an email confirmation of said sale to the customer.

25. A method as set forth in claim 20, further comprising the steps of:
monitoring said customer's responses for a predetermined amount of time;
thereafter treating the absence of any response from the customer within this predetermined amount of time as a failure by the customer to accept said offer for sale of said one or more upsell products or services; and
shipping said base product or a certificate identifying said base service to the customer.

26. An improvement in the method of selling of products or services over a global computer network comprising:
selling a base product or service to a customer and completing the sale thereof; and
thereafter offering and attempting to sell one or more upsell products or services to the customer and then completing any sale thereof while keeping the sale of the base product or service completely separate from any sale of an upsell product or service to thereby reduce compromise of a sale of the base product or service.

27. An improvement in the method of selling products or services of claim 26, further comprising consolidating the sale of the base product or service and any sale of the upsell product or service after completion of the sale thereof.

28. An improvement in the method of selling products or services of claim 26, further comprising the step of combining the upsell product or a certificate identifying the upsell service and the base product or a certificate identifying the base service together as a combination and shipping the combination.

29. An improvement in the method of selling products or services as set forth in claim 27, wherein the step of providing subsequent consolidation of sales of the products or services and notification to the customer comprises determining and informing the customer of the total price of said base product or service and any upsell products or services.

30. An improvement in the method of selling products or services as set forth in claim 29, wherein the step of notifying the customer of the total price occurs not before the time of notification to the customer.

31. An improvement in the method of selling products or services as set forth in claim 30, wherein the step of notifying the customer comprises sending an email to the customer.

32. A system for selling products or services over a global computer network, comprising:
a website within a global computer network that displays a base product or service for sale;
a means for receiving an instruction from a customer for a purchase of said base product or service;
a means for consummating a sale of said base product or service to said customer;
a means for displaying one or more upsell products or services for sale;
a means for receiving an instruction from said customer for a purchase of one or more of said upsell products or services;
a means for receiving an instruction from said customer confirming said purchase of one or more of said upsell products or services; and
a means for consummating a sale of said one or more upsell products or services to the customer.

33. A system as set forth in claim 32, wherein said means for consummating a sale of said base product or service is used before using the means for consummating a sale of said one or more upsell products or services to the customer.

34. A system as set forth in claim 32 wherein said means for consummating a sale of said one or more upsell products or services to the customer results in a wholly separate and distinct transaction from the transaction resulting from the means for consummating a sale of said base product or service.

35. A system as set forth in claim 32 wherein said means for consummating a sale of said base product or service is not dependent on the purchase of any of said upsell products or services.

36. A system as set forth in claim 32, further comprising means for subsequently consolidating the sale of the base product or service and the sale of one or more upsell products or services after consummation of said sales thereof.

37. A system as set forth in claim 36, further comprising means for consolidating of said base product and said one or more upsell products or services including sending notification of the consolidation to the customer.

38. A system as set forth in claim 37, further comprising means for determining and informing the customer of the total price along with the notification.

39. A system as set forth in claim 32 further comprising a means for shipping said base product or service to the customer together with said one or more upsell products or services.

40. A system as set forth in claim 32, further comprising:
means for measuring the amount of time that has elapsed since exercising said means for displaying one or more upsell products or services for sale; and
means for treating a lack of response from said customer within a predetermined amount of time after exercising said means for displaying one or more upsell products or services for sale as if customer declined said offer and for logging said customer off of said system.
